(19) United States
(12) Patent Application Publication
(10) Pub. No.: US 2026/0150775 A1
(43) Pub. Date: Jun. 4, 2026

(54) AGRICULTURAL GUIDANCE AND NAVIGATION SYSTEM AND RELATED DEVICES AND METHODS

(71) Applicant: Ag Leader Technology, Ames, IA (US)

(72) Inventor: David Wilson, Prairie City, IA (US)

(21) Appl. No.: 19/408,177

(22) Filed: Dec. 3, 2025

Related U.S. Application Data
(60) Provisional application No. 63/727,579, filed on Dec. 3, 2024.

(51) Int. Cl. A01B 69/04; A01B 69/00

(52) U.S. Cl. CPC A01B 69/008; A01B 69/001

(57) ABSTRACT

Devices, systems, and methods for automatically shifting agricultural guidance lines are disclosed. A system receives a field boundary, a stored AB path with an associated first guidance width, and a target guidance width for a current operation. The system determines a shift vector comprising a direction and magnitude based at least in part on the relationship between the stored AB path and the field boundary, generates a first guidance path by applying the shift vector, generates a plurality of parallel guidance paths at spacings corresponding to the target guidance width, and commands an automatic steering system to traverse the guidance paths. The system can apply selective regional shifts based on terrain, enforce boundary clearances, reconcile prior line nudges or sensor-detected crop row positions, and synchronize datasets with cloud services to preserve consistency across operations and equipment widths.

### CROSS-REFERENCE TO RELATED APPLICATION(S)

This application claims the benefit under 35 U.S.C. § 119(e) to U.S. Provisional Application 63/727,579, filed Dec. 3, 2024, and entitled Smart Shift System for Automatic AB Line Adjustment in Agricultural Operations and Related Devices and Methods, which is hereby incorporated herein by reference in its entirety for all purposes.

### TECHNICAL FIELD

The disclosure relates to precision agriculture, specifically to systems and methods for automatically adjusting AB guidance lines for agricultural machinery based on field boundaries and equipment size.

### BACKGROUND

In precision agriculture, maintaining accurate guidance lines (AB lines/paths) is important for field operations such as planting, harvesting, and spraying. Manual adjustments to AB lines/paths can be time-consuming and prone to error, especially when equipment sizes vary or when working near field boundaries.

Prior art approaches are able to determine how “far” to shift an AB line/path by evaluating 1) the guidance width the original line was created with and 2) the guidance width the user indicates that they wish to use as they load the line. However, a challenge occurs when the user doesn't know which direction to shift the line.

### BRIEF SUMMARY

Disclosed are devices, systems, and methods for “smart shifting” agricultural guidance lines. The disclosed implementations automatically determine both direction and magnitude for shifting stored AB lines/paths using known field boundaries, stored AB points, pass heading and directionality, and both stored and current guidance widths. The system generates guidance paths for the current implement width, aligns initial and subsequent passes relative to boundaries and headlands, and preserves future operability for subsequent operations that may use different implement widths. In various implementations, the system can operate locally on an operations unit and/or with cloud-connected resources to record, validate, or distribute shifts. Automatic steering systems are commanded to traverse the optimized guidance paths.

In one aspect, the system collects and/or receives: (i) boundary geometries; (ii) stored AB line(s)/path(s) including A and B points and headings; (iii) the “original” or a first guidance width; and (iv) a “target” or a second guidance width for a current operation. Using these values, the system determines a shift vector (direction and magnitude) for an initial pass and extrapolates subsequent parallel paths to fill the field with coverage for the target width. In various implementations, the system resolves directionality using boundary proximity and pass heading, thereby removing operator ambiguity when loading prior AB lines/paths for new implement widths.

The disclosed systems, methods, and devices enhance operational efficiency by reducing manual input and errors, ensuring optimal alignment for all operations, such as planting, harvesting, spraying and the like where equipment sizes may differ.

In Example 1, a method for generating guidance paths for an agricultural vehicle, the method comprising receiving a field boundary, a stored AB path comprising A and B points and a heading, the stored AB path associated with a first guidance width, receiving a target guidance width for a current operation, determining a shift vector comprising a direction and a magnitude for shifting the stored AB path based at least in part on a relationship between the stored AB path and the field boundary, generating a first guidance path by applying the shift vector to the stored AB path, generating a plurality of parallel guidance paths at spacings corresponding to the target guidance width within the field boundary, and commanding an automatic steering system of the agricultural vehicle to traverse at least one of the guidance paths.

Example 2 relates to the method of any of Examples 1 and 3-7, further comprising storing a dataset comprising the field boundary, the stored AB path, the target guidance width, and the shift vector in a cloud-based database for subsequent retrieval.

Example 3 relates to the method of any of Examples 1-2 and 4-7, further comprising enforcing a minimum boundary clearance threshold for the first guidance path and the plurality of guidance paths.

Example 4 relates to the method of any of Examples 1-3 and 5-7, wherein the stored AB path further comprises pass directionality data, and determining the shift vector comprises selecting a direction based on the pass directionality and a nearest boundary segment proximity.

Example 5 relates to the method of any of Examples 1-4 and 6-7, further comprising receiving terrain data and selectively applying regional shifts to the plurality of guidance paths in regions having slopes exceeding a threshold.

Example 6 relates to the method of any of Examples 1-5 and 7, wherein generating the plurality of parallel guidance paths comprises clipping or trimming the guidance paths to headland boundaries.

Example 7 relates to the method of any of Examples 1-6, further comprising receiving sensor data indicative of crop row positions during a subsequent operation and updating the shift vector to align the plurality of guidance paths with detected crop rows.

In Example 8, a system for generating guidance paths for agricultural operations, comprising a processor, a display, and a memory storing instructions that, when executed by the processor, cause the system to receive a field boundary, a stored AB path and a first guidance width, and a target guidance width, determine a shift vector for the stored AB path based at least in part on the field boundary and the stored AB path, generate a first guidance path and a plurality of parallel guidance paths based on the shift vector and the target guidance width, and provide commands to an automatic steering system to traverse the first guidance path.

Example 9 relates to the system of any of Examples 8 and 10-15, wherein the instructions further cause the system to simulate filling the field boundary with the plurality of guidance paths for candidate shift directions and to select the shift direction minimizing cumulative overlap or gap.

Example 10 relates to the system of any of Examples 8-9 and 11-15, wherein the instructions further cause the system to display the stored AB path, the shift vector, and the plurality of guidance paths, to receive an operator confirmation prior to commanding the automatic steering system.

Example 11 relates to the system of any of Examples 8-10 and 12-15, wherein the processor is further configured to synchronize the field boundary, the stored AB path, and the shift vector with a remote server via a communications interface.

Example 12 relates to the system of any of Examples 8-11 and 13-15, wherein the communications interface is configured to distribute the shift vector and plurality of guidance paths to multiple vehicles assigned to the same field.

Example 13 relates to the system of any of Examples 8-12 and 14-15, wherein the processor is further configured to apply smoothing to ensure continuity of guidance paths across region boundaries when regional shifts are applied.

Example 14 relates to the system of any of Examples 8-13 and 15, wherein the processor further records the shift vector and associated target guidance width keyed to a field identifier and an implement profile for subsequent use in later operations.

Example 15 relates to the system of any of Examples 8-14, wherein the processor is configured to reconcile previously recorded line nudges from prior operations when determining the shift vector for the stored AB path.

In Example 16 a system for agricultural guidance and navigation comprising a non-transitory computer-readable medium storing instructions that, when executed by one or more processors of an agricultural operations unit, cause the agricultural operations unit to receive a field boundary, a stored AB path comprising A and B points and a heading, and a first guidance width associated with the stored AB path, receive a target guidance width for a current operation, determine a shift vector comprising a direction and a magnitude for shifting the stored AB path based at least in part on a relationship between the stored AB path and the field boundary, generate a first guidance path by applying the shift vector to the stored AB path, generate a plurality of parallel guidance paths at spacings corresponding to the target guidance width within the field boundary, and command an automatic steering system of the agricultural vehicle to traverse at least one of the guidance paths.

Example 17 relates to the system of any of Examples 16 and 18-20, further comprising a storage media configured for storing a dataset comprising the field boundary, the stored AB path, the target guidance width, and the shift vector in a cloud-based database for subsequent retrieval.

Example 18 relates to the system of any of Examples 16-17 and 19-20, wherein the agricultural operations unit is further configured to retrieve a previously recorded AB path stored in a cloud database associated with the field boundary version.

Example 19 relates to the system of any of Examples 16-18 and 20, wherein the agricultural operations unit is further configured enforce a maximum cumulative error threshold across the plurality of guidance paths and adjusting the shift vector if the threshold would be exceeded near a boundary.

Example 20 relates to the system of any of Examples 16-19, wherein the instructions executed by the one or more processors further cause the agricultural operations unit to display the stored AB path, the shift vector, and the plurality of guidance paths, to receive an operator confirmation prior to commanding the automatic steering system.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1A is a schematic diagram of a guidance and visualization system on an agricultural vehicle, according to one implementation.

FIG. 1B is a system diagram showing operations system components in communication with GNSS, a display, and optional cloud services, according to one implementation.

FIG. 2 is a field-level depiction of a stored AB line/path and boundary relationship where swath width varies across different agricultural operations, according to one implementation.

FIG. 3 is a field-level depiction of the smart shift system logic apply shifts, according to one implementation.

FIG. 4 is a field-level depiction of the smart shift system logic apply shifts, according to one implementation.

FIG. 5 shows an exemplary AB line/path in a field, according to one implementation.

### DETAILED DESCRIPTION

The various implementations disclosed or contemplated herein relate to devices, systems, and methods to establish vehicle guidance paths for use by a variety of agricultural vehicles. In various implementations, the system comprises an operations system configured to acquire or access field map boundaries, stored AB lines/paths, recorded pass directionality (heading), and implement working widths (swaths). The operations system interfaces variously with one or more processors, a GNSS/GNSS-corrected positioning unit, one or more sensors, and an automatic steering unit to generate, visualize, and traverse guidance paths. In various implementations the system includes a display that provides visualization and user prompts. Optional cloud connectivity may support storage, distribution, and enterprise-level management.

As would be generally understood, as used herein the term AB lines is used for simplicity but is not limited to straight lines and would be inclusive of AB paths and the like including straight, non-straight, curved, or other lines/paths.

In certain implementations, these guidance paths may be used in agricultural operations, such as planting, harvesting, spraying, tilling, and other operations related to row crops, as would be readily appreciated. In these and other implementations, the vehicle guidance paths are used by an automatic, semi-automatic, or assisted steering system for commanding traversal of the guidance paths by an agricultural vehicle.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sept. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. Pat. No. 12,353,210, issued Jul. 8, 2025, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. Pat. No. 12,268,115, issued Apr. 8, 2025, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. Pat. No. 12,414,505, issued Sep. 16, 2025, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/556,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. Pat. No. 12,403,950, issued Sep. 2, 2025, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/766,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems and Methods,” U.S. patent application Ser. No. 18/980,728, filed Dec. 13, 2024, entitled “Deck Plate Spacing Sensors and Related Devices, Systems, and Methods,” U.S. patent application Ser. No. 19/041,787, filed Jan. 30, 2025, entitled “Grain Cart Unloading Sensor and Unload Control System and Associated Devices and Methods,” U.S. patent application Ser. No. 19/207,115, filed May 13, 2025, entitled “Devices, Systems, and Methods for Planter and Seed Trench Imaging and Analysis,” U.S. patent application Ser. No. 19/219,718, fled May 27, 2025, entitled “Devices, Systems, and Methods for Agricultural Navigation and Positioning,” U.S. patent application Ser. No. 19/226,004, filed Jun. 2, 2025, entitled “Devices, Systems, and Methods for Machinery Monitoring and Reporting,” U.S. Patent Application 63/667,546, filed Jul. 3, 2024, entitled “Cover for Port Openings,” U.S. patent application Ser. No. 19/260,159, filed Jul. 3, 2025, entitled “Agricultural Seed Meters and Related Devices, Systems and Methods,” U.S. patent application Ser. No. 19/297,963, filed Aug. 12, 2025, entitled “Agricultural Navigation and Steering Systems, Devices and Methods,” U.S. patent application Ser. No. 19/305,530, filed Aug. 20, 2025, entitled “Crop Sensor Wands and Related Devices, Systems, and Methods,” U.S. patent application Ser. No. 19/366,202, filed Oct. 22, 2025, entitled “Crop Sensors and Related Devices, Systems, and Methods,” U.S. patent application Ser. No. 19/367,363, filed Oct. 23, 2025, entitled “Agricultural Sprayer Sensor and Related Devices, Systems, and Methods,” U.S. patent application Ser. No. 19/390,280, filed Nov. 14, 2025, entitled “Liquid Product Distribution for Agricultural Spraying Systems and Related Devices and Methods,” U.S. patent application Ser. No. 19/396,099, filed Nov. 20, 2025, entitled “Sprayer Nozzle Devices and Related System and Methods,” U.S. patent application Ser. No. 19/396,047, filed Nov. 20, 2025, entitled “Agricultural Harvesting Systems and Related Devices and Methods,” U.S. patent application Ser. No. 19/397,422, filed Nov. 21, 2025 entitled “Systems, Methods, and Devices for Increasing Machine Operating Range,” U.S. Patent Application 63/752,279, filed Jan. 31, 2025, entitled “System and Automatic Adjustment to Target Pressure and Related Devices and Methods,” U.S. Patent Application 63/752,341, filed Jan. 31, 2025, entitled “Harvester Liquid Application System, Devices, and Methods,” U.S. Patent Application 63/753,258, filed Feb. 3, 2025, entitled “Agricultural Navigation Methods, Devices, and Systems,” U.S. Patent Application 63/753,201, filed Feb. 3, 2025, entitled “Agricultural Mapping and Related Devices, Systems, and Methods” U.S. Patent Application 63/755,675, filed Feb. 7, 2025, entitled “Remote Assistance for Agricultural Display Methods and Related Devices and Systems,” U.S. Patent Application 63/757,242, filed Feb. 11, 2025, entitled “Seed Meter,” U.S. Patent Application 63/757,434, filed Feb. 12, 2025, entitled “Grain Fill Sensor,” U.S. Patent Application 63/760,907, filed Feb. 20, 2025, entitled Agricultural Yield Monitoring and Estimation Devices, Systems, and Methods,” U.S. Patent Application 63/816,284, filed Jun. 2, 2025, entitled “Agricultural Guidance and Navigation Systems, Methods, and Devices,” U.S. Patent Application 63/817,692, filed Jun. 4, 2025, entitled “Intelligent Steering System for Sprayers and Tractors in Standing Crops,” U.S. Patent Application 63/818,248, filed Jun. 5, 2025, entitled “Devices, Systems, and Methods for Determining Implement Pose,” U.S. Patent Application 63/906,692, filed Oct. 28, 2025, entitled “Agricultural Alignment System and Related Devices and Methods,” U.S. Patent Application 63,906,646, filed Oct. 28, 2025, entitled “Automated Grail Filling System and Related Devices and Methods,” each of which is incorporated herein by reference.

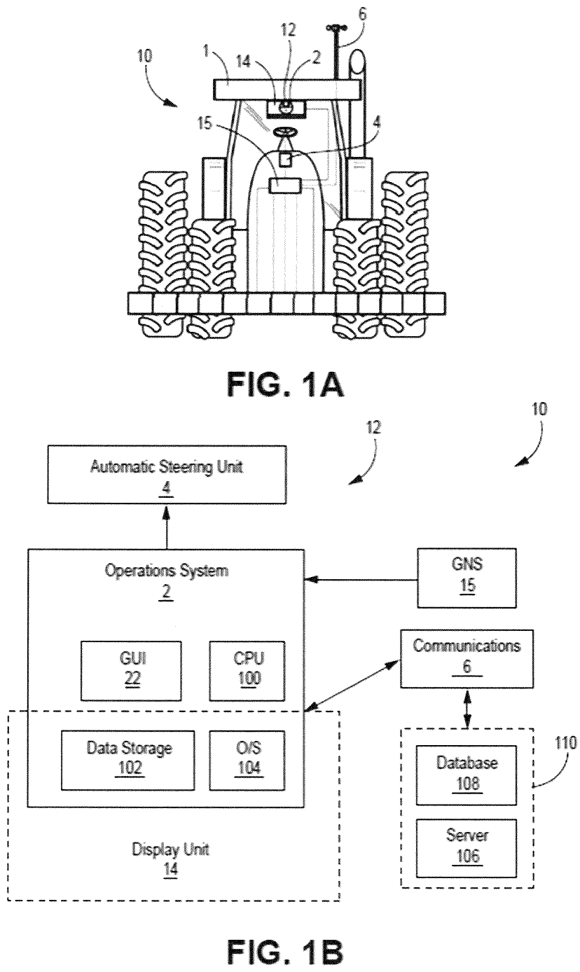

Turning to the drawings in greater detail, FIGS. 1A-1B depict exemplary implementations of the various visualization and guidance system 10 components fitted to an agricultural vehicle 1. In various implementations, the agricultural vehicle 1 may be a tractor 1, optionally having an implement such as a planter, as would be understood. It is understood that a variety of vehicles 1 and implements can be utilized in various implementations, such as a harvester, sprayer, tiller, and the like. It is further understood that the components depicted in FIGS. 1A-1B are optional, and can be utilized or omitted in the various claimed implementations, and that certain additional components may be required to effectuate the various processes and systems described herein. Such additional components may include hardware, software, firmware, and other electronic components that would be known and appreciated by those of skill in the art.

As shown in FIG. 1A, the visualization and guidance system 10 has an operations system 2 that comprises or is configured to be operationally integrated with a steering unit 4, such as SteerCommand®, and an optional communications component 6. The system 10 is operationally integrated with at least one in-cab display 14, such as an InCommand® display 14, or other suitable display 14 understood in the art. It is appreciated that certain of these displays 14 feature touchscreens, while others are equipped with necessary components for interaction with the various prompts and adjustments discussed herein, such as via a keyboard or other interface.

In various implementations, the system 10 is also operationally integrated with a GNSS or GPS unit 15, such as a GPS 7500, such that the system 10 is configured to input positional data for use in defining boundaries, locating the vehicle 1, plotting guidance, navigating guidance paths, and the like, as would be readily appreciated from the present disclosure.

As shown in FIG. 1B, in various implementations, the operations system 2 is optionally in operational communication with the automatic steering unit 4 or controller 4, the communications component 6, and/or GNSS 15. In certain of these implementations, the operations system 2 is housed in the display 14, though the various components described herein can be housed elsewhere, as would be readily appreciated.

As shown in FIG. 1B, the operations system 2 further has one or more optional processing and computing components, such as a CPU/processor 100, data storage 102, operating system 104, and other computing components necessary for implementing the various technologies disclosed herein. It is appreciated that the various optional system components are in operational communication with one another via wired or wireless connections and are configured to perform the processes and execute the commands described herein.

In certain implementations, like that of FIG. 1B, the communications component 6 is configured for the sending and receiving of data for cloud 110 storage and processing, such as to a remote server 106, database 108, and/or other cloud computing components readily understood in the art. Such connections by the communications component 6 can be made wirelessly via understood internet and/or cellular technologies such as Bluetooth, WiFi, LTE, 3G, 4G, or 5G connections and the like. It is understood that in certain implementations, the communications component 6 and/or cloud 110 components comprise encryption or other data privacy components such as hardware, software, and/or firmware security aspects. In various implementations, the operator or enterprise manager or other third parties are able to receive notifications such as adjustment prompts and confirmation screens on their mobile devices, and in certain implementations can review the plotted guidance paths and make adjustments via their mobile phones.

From the foregoing exemplary implementations, it is understood that in use, various implementations of the smart shift system 10 comprises a variety of optional steps and sub-steps automating path plotting and execution. Various of the optional steps and sub-steps described in the smart shift system 10 can be performed manually, via automation or calculation, or can be retrieved or commanded remotely, as would be readily understood. Further, the various optional steps and sub-steps described herein may be performed contemporaneously or sequentially in any order and in certain implementations iteratively, as would be readily appreciated.

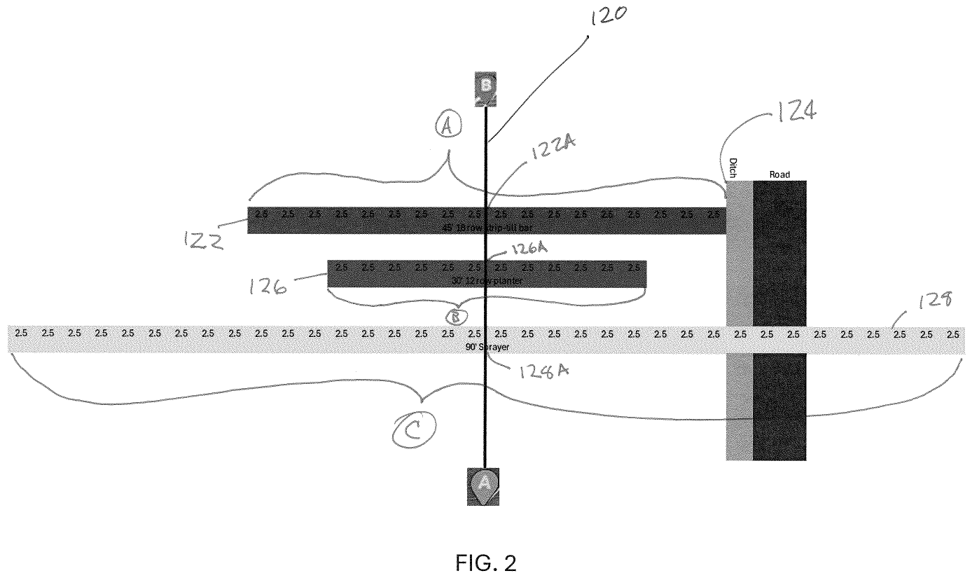

FIG. 2 depicts a typical challenge in adapting implements of different sizes in subsequent operations. In an exemplary implementation, an AB path 120 is recorded as GPS coordinates during a first operation, such as a strip tilling or fertilizer application. It is understood that in this operation, a first implement bar 122, such as a 45′ 18-row strip till bar 122, traverses a first swath width (shown at bracket A). The first swath width (bracket A) is coextensive with the width of the strip till bar 122, which places the first operation center 122A of the first implement bar 122 (and therefore the lateral location of the AB path 120) at a given distance from the edge 124, here at 9 rows (½ of the 18-row strip till bar 122).

In this example, in a subsequent operation such as planting, a 30′ 12-row planter bar 126 may be used. In this example, the second operation center 126A is at the midpoint of the second operation swath (bracket B). And in a further, third, operation such as spraying via a 90′ sprayer bar 128 has a third operation swath width (bracket C) and third operation center 128A.

It would be appreciated that if the same AB path 120 is used for the second and third operations, the second and third swaths (brackets B and C, respectively) will not result in the edges of the respective bars 126, 128 being properly aligned with the field edge/boundary 124, as is illustrated in FIG. 2.

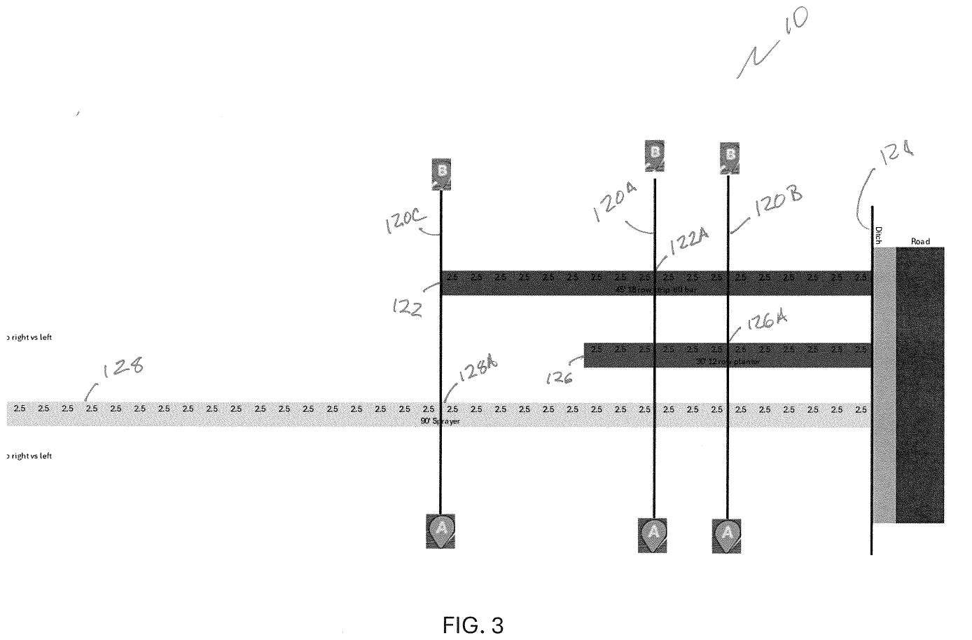

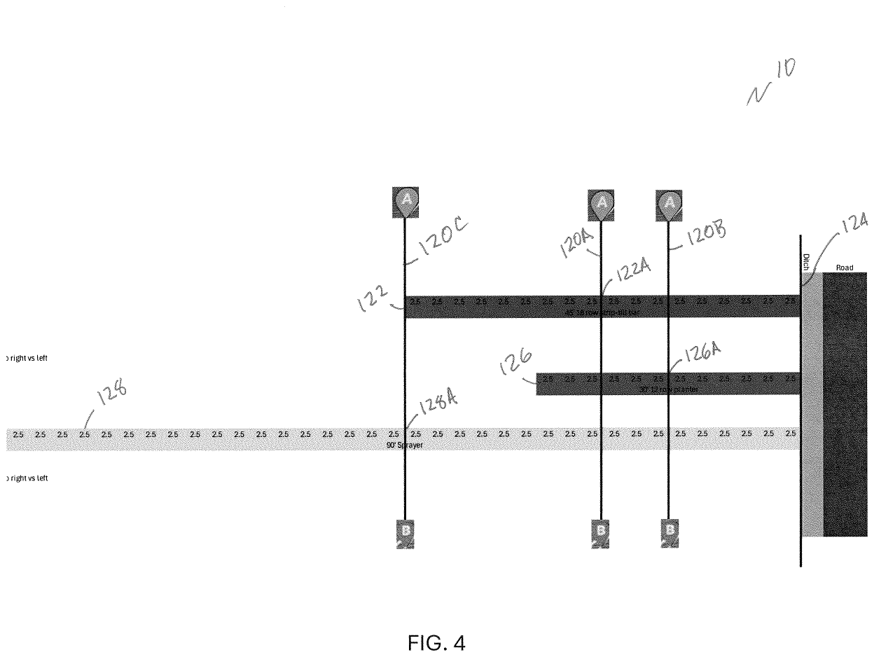

In certain implementations of the smart shift system 10 is configured to collect guidance width data as to the various swath widths (brackets A, B and C) as well as the AB paths 120A, 120B, 120C (shown in FIG. 3) (including, optionally, the directions/headings of those lines) and the field boundaries 124 via the control unit or operations system 2. With these values and information, the operations system 2 is then able to compare a current AB path 120A to the field boundaries 124 and calculate the shift direction and distance (vector) for subsequent operations.

In these implementations, the system 10 shifts the AB paths 120B, 120C automatically, taking into account future operations and implement sizes, such as smaller planters 126 and larger sprayers 128, as is shown for example in FIG. 3.

When an A-B guidance line 120A is present, the operations system 2 is configured to determine how the A-B guidance line 120A relates to the boundary 124, as described herein. For example determining, the distance, number of rows, or other measure that the A-B guidance line 120A is from the boundary 124. The system 10, according to these implementations, then extrapolates the requite shifts for subsequent AB paths 120B, 120C, so as to populate the field with appropriate guidance lines for the given swath width (brackets B & C).

That is, according to these implementations, the system 10 is configured to determine whether the stored A-B guidance line 120A from the prior pass is appropriately spaced relative to the boundary 124 for the subsequent implement width (bracket B). Accordingly, the operations system 2 may then extrapolate that the first AB path 120A was created with, for example, a first guidance width (bracket A) and the user now has a second guidance width (bracket B). The operations system 2 can therefore establish the direction and amount (vector) to shift the subsequent guidance line 120B, as the second implement width (bracket B) is smaller than the original A so the guidance line should shift closer to the boundary by an amount of [(A−B)]/2, as would be understood. It is understood that this extrapolation and population can be done regardless of the direction of travel (arrow T) of any given implement.

Additionally, for a implement having a width/swath (bracket C) larger than the width/swath of the first or second implement 122, 126 (brackets A and B) the guidance line should shift further from the boundary by and amount of [(C−A)]/2

In various further implementations, the system 10 may shift A-B guidance lines along curves, as well as adjust pivot points for implements as would be appreciated. That is, as the swath width changes so to does the turn radius for the implement as such shifts in the A-B guidance lines are necessary to accommodate different swath width along curves and turns/pivots.

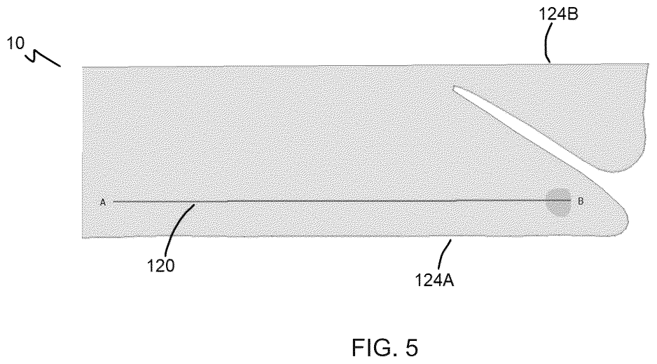

In certain implementations, the guidance lines are saved in the system 10 with two or more points—A and B. As discussed herein, the system 10 may calculate a distance from both points of the line (A and B) to a nearest boundary and apply a shift in the guidance line accordingly. Certain A-B guidance lines may include a defined A and B points, shown for example in FIG. 5. In this example, the system 10 would determine that the A-B guidance line 120 is closer to the south boundary 124A than the north boundary 124B. As such when returning to the field with a larger swath (e.g., 40′ swath) than the swath the A-B guidance line 120 was originally created with (e.g., 30′ swath) the A-B guidance line 120 is shifted by the system 10 toward the northern boundary 124B (in this example by 5′).

In various implementations, the smart shift system 10 optionally applies constraints, such as minimum boundary clearance, headland priorities, and enterprise presets for downstream operations, to the guidance paths. The system 10 may also incorporate slope or terrain model data to refine selective shift application, particularly on side slopes where pass-to-pass convergence/divergence behavior may benefit from compensated spacing or asymmetrical margining.

In various implementations of the system 10 a stored AB path is created using a first guidance width and a target guidance width for a first implement, the system 10 computes a recommended shift vector comprising a lateral offset magnitude and direction for use of a second implement. Unlike prior approaches that leave the operator to decide a shift to the left or right, the system 10 discussed above evaluates the relationship between the stored AB path and the nearest boundary segments, headlands, and previously recorded pass directionality to determine the correct shift direction that preserves boundary clearance and minimizes cumulative error propagation.

The system 10 can then project the shifted first pass and automatically generate subsequent passes to fill the field at the target/selected width/implement. Where headlands or obstacles are present, the system 10 may be configured to adjust guidance paths accordingly and maintains required clearance thresholds. That is, the operations system 2 extrapolates and populates the field with guidance paths for the target width based on the shifted initial pass. The spacing reflects the target implement width, with constraints to prevent cumulative overlaps/skips at boundaries. The system 10 can further record the shift mapping so that future operations, using different widths, can be derived from the same AB datum with correct directionality. In one implementation, the system 10 stores the current AB path and associated shift in a data model keyed to the field boundary version and implement profile, enabling replay in a later season on different equipment.

The system 10 may incorporate stored shifts from prior operations or real-time sensing to reconcile recorded versus actual crop positions and refine path placement for harvesting or in-season spraying. In some implementations, selective shifting is applied regionally, for example, applying a differential shift for a sloped region to account for terrain-induced drift behaviors while leaving flat regions unshifted.

The system optionally fuses data from crop sensors, such as stalk or row sensors, or row-position estimation techniques, to validate or refine the offset between recorded AB paths and actual crop positions, particularly for harvest operations. Where prior operations recorded line nudges or where terrain-aware shifting was applied, the system 10 can reconcile those adjustments into the current shift logic to enhance accuracy.

Upon acceptance of the shifted guidance lines, the system 10 commands the automatic steering unit to traverse the shifted first pass and subsequent passes, maintaining alignment with the computed paths. If the system 10 detects deviation beyond a tolerance (e.g., due to GNSS correction transitions or implement drift) the system 10 can apply micro-adjustments or prompt the operator.

In various implementations the system 10 may be integrated with an enterprise system that deploys multiple tractors and combines. In these and other implementations, the system 10 synchronizes shifted AB path sets to all vehicles assigned to the field. Operators in these implementations may see a consistent, direction-resolved set of guidance paths regardless of machine assignment, reducing setup time and errors.

Although the disclosure has been described with references to various embodiments, persons skilled in the art will recognize that changes may be made in form and detail without departing from the spirit and scope of this disclosure.

What is claimed is:

1. A method for generating guidance paths for an agricultural vehicle, the method comprising:
receiving a field boundary, a stored AB path comprising A and B points and a heading, the stored AB path associated with a first guidance width;
receiving a target guidance width for a current operation;
determining a shift vector comprising a direction and a magnitude for shifting the stored AB path based at least in part on a relationship between the stored AB path and the field boundary;
generating a first guidance path by applying the shift vector to the stored AB path;
generating a plurality of parallel guidance paths at spacings corresponding to the target guidance width within the field boundary; and
commanding an automatic steering system of the agricultural vehicle to traverse at least one of the guidance paths.

2. The method of claim 1, further comprising storing a dataset comprising the field boundary, the stored AB path, the target guidance width, and the shift vector in a cloud-based database for subsequent retrieval.

3. The method of claim 1, further comprising enforcing a minimum boundary clearance threshold for the first guidance path and the plurality of guidance paths.

4. The method of claim 1, wherein the stored AB path further comprises pass directionality data, and determining the shift vector comprises selecting a direction based on the pass directionality and a nearest boundary segment proximity.

5. The method of claim 1, further comprising receiving terrain data and selectively applying regional shifts to the plurality of guidance paths in regions having slopes exceeding a threshold.

6. The method of claim 1, wherein generating the plurality of parallel guidance paths comprises clipping or trimming the guidance paths to headland boundaries.

7. The method of claim 1, further comprising receiving sensor data indicative of crop row positions during a subsequent operation and updating the shift vector to align the plurality of guidance paths with detected crop rows.

8. A system for generating guidance paths for agricultural operations, comprising:
(a) a processor;
(b) a display; and
(c) a memory storing instructions that, when executed by the processor, cause the system to:
(i) receive a field boundary, a stored AB path and a first guidance width, and a target guidance width;
(ii) determine a shift vector for the stored AB path based at least in part on the field boundary and the stored AB path;
(iii) generate a first guidance path and a plurality of parallel guidance paths based on the shift vector and the target guidance width; and
(iv) provide commands to an automatic steering system to traverse the first guidance path.

9. The system of claim 8, wherein the instructions further cause the system to simulate filling the field boundary with the plurality of guidance paths for candidate shift directions and to select the shift direction minimizing cumulative overlap or gap.

10. The system of claim 8, wherein the instructions further cause the system to display the stored AB path, the shift vector, and the plurality of guidance paths, to receive an operator confirmation prior to commanding the automatic steering system.

11. The system of claim 8, wherein the processor is further configured to synchronize the field boundary, the stored AB path, and the shift vector with a remote server via a communications interface.

12. The system of claim 11, wherein the communications interface is configured to distribute the shift vector and plurality of guidance paths to multiple vehicles assigned to the same field.

13. The system of claim 8, wherein the processor is further configured to apply smoothing to ensure continuity of guidance paths across region boundaries when regional shifts are applied.

14. The system of claim 8, wherein the processor further records the shift vector and associated target guidance width keyed to a field identifier and an implement profile for subsequent use in later operations.

15. The system of claim 8, wherein the processor is configured to reconcile previously recorded line nudges from prior operations when determining the shift vector for the stored AB path.

16. A system for agricultural guidance and navigation comprising a non-transitory computer-readable medium storing instructions that, when executed by one or more processors of an agricultural operations unit, cause the agricultural operations unit to:
receive a field boundary, a stored AB path comprising A and B points and a heading, and a first guidance width associated with the stored AB path;
receive a target guidance width for a current operation;
determine a shift vector comprising a direction and a magnitude for shifting the stored AB path based at least in part on a relationship between the stored AB path and the field boundary;
generate a first guidance path by applying the shift vector to the stored AB path;
generate a plurality of parallel guidance paths at spacings corresponding to the target guidance width within the field boundary; and
command an automatic steering system of the agricultural vehicle to traverse at least one of the guidance paths.

17. The system of claim 16, further comprising a storage media configured for storing a dataset comprising the field boundary, the stored AB path, the target guidance width, and the shift vector in a cloud-based database for subsequent retrieval.

18. The system of claim 16, wherein the agricultural operations unit is further configured to retrieve a previously recorded AB path stored in a cloud database associated with the field boundary version.

19. The system of claim 16, wherein the agricultural operations unit is further configured enforce a maximum cumulative error threshold across the plurality of guidance paths and adjusting the shift vector if the threshold would be exceeded near a boundary.

20. The system of claim 16, wherein the instructions executed by the one or more processors further cause the agricultural operations unit to display the stored AB path, the shift vector, and the plurality of guidance paths, to receive an operator confirmation prior to commanding the automatic steering system.
